(19) United States
(12) Patent Application Publication
(10) Pub. No.: US 2013/0302703 A1
(43) Pub. Date: Nov. 14, 2013

(54) MICROBIAL FUEL CELL

(71) Applicant: SYNTHETIC GENOMICS, INC., LA JOLLA, CA (US)

(72) Inventors: Orianna Bretschger, San Diego, CA (US); Greg Wanger, San Diego, CA (US)

(73) Assignee: SYNTHETIC GENOMICS, INC., LA JOLLA, CA (US)

(21) Appl. No.: 13/892,087

(22) Filed: May 10, 2013

Related U.S. Application Data
(60) Provisional application No. 61/645,491, filed on May 10, 2012.

(51) Int. Cl. H01M 8/16

(52) U.S. Cl. CPC H01M 8/16
USPC 429/401

(57) ABSTRACT

Disclosed is a high surface area electrode for use in a microbial fuel cell. In one embodiment the high surface area electrode has an electrode backing and villiated extensions attached to the backing. In one embodiment the villiated extensions and/or electrode backing are made of an electro conductive material such as, for example, graphite or graphite fibers. In one embodiment the electrode is an anode and the electrode backing is in the form of a mesh or woven structure. The electrodes offer superior removal of chemical oxygen demand (COD) and are thus useful in the remediation of wastewaters. The invention also provides microbial fuel cells that utilize the electrodes of the invention. In one embodiment the microbial fuel cells utilize an oxygen barrier and do not utilize a cation or anion or proton exchange membrane.

### CROSS-REFERENCES TO RELATED APPLICATIONS

This application claims benefit of U.S. provisional patent application 61/645,491, filed May 10, 2012, which is incorporated by reference in its entirety.

### FIELD OF THE INVENTION

The invention pertains to microbial fuel cells, specialized designs, anodes and cathodes therefor.

### BACKGROUND

The following description of the background of the invention is provided to aid in understanding the invention, but is not admitted to be, or to describe, prior art to the invention.

Microbial fuel cells (MFCs) represent an opportunity not only for inexpensive and renewable energy generation, but also a means for the remediation of wastewater that might otherwise be unsafe to dispose of without incurring significant expense to remove organic contaminants that could cause harmful effects on the environment. These MFCs function by harnessing the ability of microorganisms to oxidize organic substrates and provide electrons to an electrode. When organic substrates are provided in the form of bio-convertible substrates present in a variety of types of wastewaters and other fluids, one can achieve the dual advantage of generating electricity while at the same time providing remediation to the wastewater or other fluid. Generally bacteria present at an anode oxidize organic substrates under anaerobic conditions to produce electrons and protons. The electrons are transferred to the anode and flow to the cathode through an electric circuit connected to the cathode compartment. The cathode compartment contains an oxidant (e.g., oxygen), which is reduced by the electrons and protons and produces H₂O, H₂O₂, or OH⁻). The anode and the cathode generally are separated by a proton exchange membrane. The difference in electrical potential between the anode and the cathode drives electrical current through an external electrical coupling.

A variety of MFCs have been presented for this purpose. Some have sought to optimize efficient operation by utilizing electrogenic bacteria, thus eliminating the use of a mediator to transfer the electrons from the bacteria to the anode. Other MFCs have sought to achieve greater efficiency in energy recovery or waste remediation by modifying the anode or cathode components, or by altering the microbial population at the anode.

However, the MFCs presented thus far generally use expensive materials that cannot be economically used in many commercial applications. There is still a need in the art for an MFC design that achieves greater efficiency in the operation of an MFC to generate electricity as well as provide remediation of wastewater, and to be constructed of materials that are widely available and inexpensive enough to be applied economically on a commercial scale.

### SUMMARY OF THE INVENTION

The present invention provides a high surface area electrode for use in a microbial fuel cell. In one embodiment the high surface area electrode comprises an electrode backing and villiated extensions attached to the backing. In one embodiment the villiated extensions and/or electrode backing are made of an electroconductive material such as, for example, graphite or graphite fibers. In one embodiment the electrode is an anode and the electrode backing is in the form of a mesh. The electrodes of the invention are used in microbial fuel cells to achieve superior removal of chemical oxygen demand (COD) and are thus useful in the remediation of wastewaters. The invention also provides microbial fuel cells that utilize the electrodes of the invention. In one embodiment the microbial fuel cells utilize an oxygen barrier and do not utilize a proton exchange membrane. In another embodiment the anode is configured for substantially linear, unobstructed flow of liquid through the anode. The microbial fuel cells of the invention can also use a chemically-treated anode, and optionally utilize a heat-treated cathode, either or both treatments conferring superior properties on the microbial fuel cells.

In a first aspect the invention provides a high surface area electrode having an electrode lead and an electrode backing, wherein the electrode lead and the electrode backing are made of an electroconductive material, and the electrode backing is in the form of a mesh. The electrode has villiated extensions attached to the backing, which are made of an electroconductive material and provide a surface area for the growth of microorganisms and for transmitting an electric current. The electrode lead and the electrode backing can be made of a variety of conductive materials, such as 1) a metal such as titanium, platinum, gold, and an electrically conductive alloy of any two or more thereof; or 2) a metal compound such as cobalt oxide, ruthenium oxide, a tungsten carbide, a tungsten carbide cobalt, a stainless steel, or a combination of any two or more thereof; or 3) a non-metal conductive material such as graphite, a graphite-doped ceramic, a conducting polymer (e.g., polyaniline), and manganese-oxide coated graphite. In one embodiment the villiated extensions are graphite fibers.

In one embodiment the electrode lead and the electrode backing are made of the same electroconductive material. In another embodiment the electrode lead is the electrode backing, and are portions of the same piece of electroconductive material. The villiated extensions can be comprised entirely of an electroconductive material, and in one embodiment are made of graphite. But in other embodiments the villiated extensions are made of graphite, graphite-doped ceramic, carbon, a conducting polymer, polyaniline, stainless steel, titanium, copper, gold, platinum, palladium, or a combination of any of these. The villiated extensions can also be carbon nanotubules. The villiated extensions can also be conductive fibers having a form selected from the group consisting of: solid, hollow, semi-permeable, porous, nano-tubule, and branched.

In one embodiment the villiated extensions are substantially free of insulating substances. The villiated extensions can be chemically treated or heat-treated. The insulating substances can be one or more substances such as aluminum, silicon, and an oxide layer.

The anode can be a packed bed configuration and contain a plurality of spherically shaped objects, and the villiated extensions can be present on the spherically shaped objects (e.g. on the exterior surface of the spherically shaped objects).

In another aspect the present invention provides a microbial fuel cell having an anode contained in an anode chamber and suitable for supporting a bacterial population that oxidizes an oxidizable material and provides electrons to an electron acceptor on the anode; a cathode contained in a cathode chamber and having an oxidant that receives electrons from the anode; an electrically conductive path connecting the anode in the anode chamber and the cathode in the cathode chamber; and an oxygen barrier or separator separating the anode chamber and the cathode chamber, wherein the oxygen barrier or separator is not a cation or anion exchange membrane. The oxygen barrier or separator is also not a proton exchange membrane. The anode can be any anode described herein. In one embodiment the oxygen barrier or separator is not chemically functionalized, and in another embodiment the oxygen barrier is a polydimethyl siloxane (PDMS) separator. The separator can be impregnated with or coated with the PDMS. The anode chamber can be configured for substantially linear flow of liquid through the anode. The anode can be any anode described herein. In one embodiment the anode chamber is configured in a generally circular form and the cathode chamber surrounds the anode chamber along at least one axis.

In one embodiment the anode is a packed bed anode and contains a plurality of spherically shaped objects, and villiated extensions are present on the spherically shaped objects. The spherically shaped objects can be hollow and have an exterior surface and an interior surface. The spherically shaped objects can have holes, and can have villiated extensions present on the interior and/or exterior surfaces.

The microbial fuel cells of the invention can be configured in tandem to form a module of microbial fuel cells, where a fluid passage connects the anode compartment of one fuel cell with the anode compartment of another fuel cell.

In another aspect the present invention provides a microbial fuel cell having a chemically-treated anode made of an electroconductive material and providing a surface area for supporting a population of microorganisms; a cathode made of an electroconductive material configured to receive electrons from the anode; and an electrically conductive path connecting the anode to the cathode and allowing for an electrical current to pass between the anode and the cathode. The cathode can be a heat-treated cathode. And the anode can be chemically-treated (e.g., with acetone or sodium hydroxide). The anodes can otherwise be any electrode described herein.

The summary of the invention described above is not limiting and other features and advantages of the invention will be apparent from the following detailed description of the invention, and from the claims.

### BRIEF DESCRIPTION OF THE DRAWINGS

FIG. 1 provides a graphical illustration of a microbial fuel cell of the invention in tubular design, with the anode on the inside and the cathode on the outside.

FIG. 2 provides a graphical illustration of a cross-section of the microbial fuel cell depicted in FIG. 1.

FIG. 3 provides a graphical illustration of a close up view of the villiated extensions utilized in an electrode of the invention, which are depicted as having been colonized by microorganisms.

FIG. 4 provides a graphical illustration of an anode and cathode of the invention, depicted with the anode in a circular formation facing inward and the cathode in a circular formation facing outward.

FIG. 5 provides a graphical illustration of an example of how the microbial fuel cells of the invention can be combined to form a modular wastewater treatment system.

FIG. 6 provides a chart showing that higher current is generated in the MFC when chemically treated anode electrodes are used.

FIG. 7 provides a chart showing that higher current per microbial cell is generated in the MFC when chemically treated anode electrodes are used.

FIG. 8 provides a chart showing that higher cathode polarization is obtained when the cathode material (in this case graphite fiber) is heat-treated.

### DETAILED DESCRIPTION

The electrodes disclosed herein are broadly applicable to a variety of applications, and provide several distinct advantages. In various embodiments the electrodes of the invention can be applied to the construction of microbial fuel cells, to batteries, to the remediation of wastewater or other remediation systems, and to the production of electricity. The electrodes and microbial fuel cells of the invention provide distinct advantages, such as a greatly expanded electrode surface area, higher available power density, more efficient and superior wastewater remediation, and greater electricity generation. The greater surface area of the electrodes of the invention provides a much greater surface area over which microorganisms can colonize the anode and provide electrons to the cathode. Another beneficial aspect of the electrodes and fuel cells of the invention is that they are designed to be low weight instruments that are constructed of inexpensive materials that are readily available. Thus, they can be more easily and inexpensively manufactured, transported, and set up (or taken down).

Any oxidizable substrates or degradable molecules can be used as a source of electrons in a microbial fuel cell of the invention. Advantageously, the invention can be applied to the remediation of wastewater from various sources such as municipal or household wastewater, or industrial wastewater from many sources such as pulp and paper plants, petrochemical processes, agricultural wastewater (e.g., swine wastewater, dairy wastewater, corn stover, etc.), effluents of anaerobic digesters, and wastewater from the food and beverage industry. In particular examples, brewery wastewater or wastewater from the manufacture of coffee can be utilized. But the microbial fuel cells of the invention will find many applications. In these applications a microbial fuel cell has the dual advantage of not only performing remediation on the wastewater, but also recovering energy (e.g., to generate electricity) in the process. The particular source of feed water is not important, as long as it contains oxidizable substrates that can be utilized by the microbial organisms present in a microbial fuel cell of the invention. The oxidizable substrates can be any substrate oxidizable by a microorganism but in particular examples can include organic substrates present in wastewaters, e.g., containing acetate, propionate, and butyrate. The oxidizable materials can be broken down by the MFCs of the invention to CO₂ and water. When wastewater contaminants reach safe levels the wastewater can be easily disposed of.

### Electrode Backing

The present invention provides a high surface area electrode for use in a microbial fuel cell. In one embodiment the high surface area electrode comprises villiated extensions that are attached to the backing of the electrode. The backing of the electrode indicates that portion to which the villiated extensions are attached and to which the electrode lead is attached. In one embodiment the electrode backing is constructed of an electroconductive material, and can be present in the form of a woven material such as a cloth or mesh of electroconductive material. The mesh is a knit, woven, grating, cloth, or knotted fabric or structure of open texture. The backing in a woven or mesh form can be tightly or loosely woven graphite or carbon, such as a plain weave graphite cloth, but can also be made of a variety of conductive materials such as stainless steel, titanium, or any material having electroconductive properties. In one embodiment the electrode backing is a conductive mesh, cloth, or grating comprised of graphite or stainless steel. The woven cloth, mesh, or grating form can be from 0% to 99% open, meaning that when considered from one dimension from 1% to 99% of the space is open space and correspondingly from 99% to 1% of the space is occupied by the woven cloth, mesh, or grating form. In various embodiments, the woven, mesh, or grating form is from 25% to 50% open, or from 50% to 75% open, or from 25% to 75% open, or from 50% to 90% open. The electrode backing can be sized to any appropriate scale depending on the application. Thus, in some embodiments the backing is a nanofabricated mesh, a graphite cloth mesh, or a stainless steel grating, but in other large-scale embodiments the backing is an industrial scale grating.

In various embodiments the backing of the anode has a surface area of at least 1.0 cm²/cm² of backing, or at least 1.25 cm²/cm² of backing or at least 5 cm²/cm² of backing or at least 10 cm²/cm² of backing. In one embodiment where the electrode backing is a graphite cloth the graphite cloth has a tow density of about 3 tows/sq-cm. In one embodiment where the electrode backing is a stainless steel mesh it also has a tow density of about 3 tows/sq-cm. In some embodiments the electrode backing is a plain weave graphite cloth and can have a density of about 1.5 g/cm³ or about 1.75 g/cm³ or about 2.0 g/cm³. In some embodiments the electrode backing has a weave count of about 113×113 yarns/10 cm±10%. The thickness of the cloth is any appropriate thickness, e.g., 500-700 um or 700-900 um or 800-1000 um.

### Electrode Leads

The electrodes (anode and/or cathode) can have an electrode lead. The electrode lead is that portion of the electrode that connects the electrode (anode or cathode) to the electrically conductive path connecting the anode and cathode. The electrode lead can be a separate structure that provides an electrical connection between the electrode and the electrically conductive path, but it can also be simply a portion of the electrode. In some embodiments the electrically conductive path will pass through a capacitor, re-chargeable battery, or other device that collects or uses electricity generated by the fuel cell before passing to the opposite electrode. In various embodiments the MFCs of the invention can provide a coulombic yield of at least 3% or at least 5% or at least 10% or at least 15% or at least 20% or at least 30%. The coulombic efficiency of the MFCs of the invention can be greater than 1% or greater than 2% or greater than 5% or greater than 7% or greater than 10% or greater than 15%.

The electrode leads can be comprised of any electroconductive material. Any of the electroconductive materials listed as being able to form the backing or the villiated extensions can also be used to form the electrode leads. In one embodiment the electrode lead and the electrode backing are both comprised of an electroconductive material. In another embodiment the electrode lead (of the anode, cathode, or both) is comprised of the same electroconductive material as the electrode backing. In another embodiment the electrode lead is the electrode backing, i.e, a portion of the material used to form the electrode backing is extended to form the electrode lead.

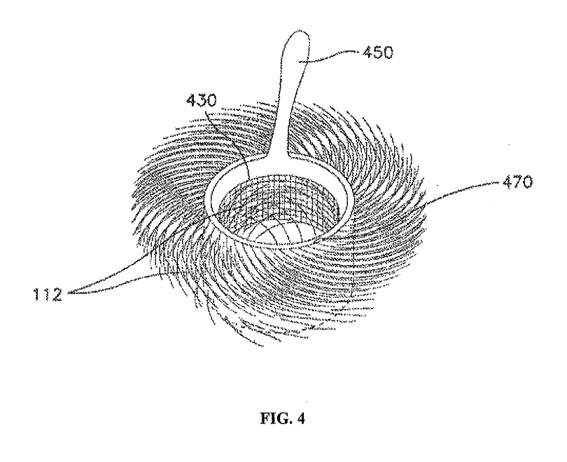

Conventional microbial fuel cells are designed with the anode or cathode comprising one electroconductive material and the electrode lead comprising a different electroconductive material. It was discovered that by utilizing the same electroconductive material for the electrode lead and the electrode backing, a significant decrease in resistivity is achieved, resulting in greater efficiency of current transfer. Thus, in one embodiment the electrode backing is the electrode lead, and no separate lead is provided to the electrode. In another embodiment the conductive path connecting the anode to the cathode is made of the same material as the electrode backing and the electrode lead. With reference to FIG. 4, there is depicted an anode and cathode of the present invention. In this embodiment the anode comprises villiated extensions 112 that extend inwardly from the anode backing 430, and the cathode contains villiated extensions that extend outwardly from the cathode backing 470. In this embodiment the anode backing is comprised of a graphite mesh. The anode lead 450 comprises, in this embodiment, a graphite fiber bundle derived from the same graphite mesh utilized in forming the anode backing 430. Thus, in this embodiment the electrode backing is the electrode lead. The electrode lead and the electrode backing are comprised of electroconductive materials, which are materials that contain movable electrons. The electrons move when an electric potential difference is applied across separate points on the material. Examples of electroconductive materials include metals, metal compounds, or non-metal conductive materials. In particular examples the electroconductive material can be a metal such as titanium, platinum, gold, copper, platinum, aluminum, silver, and an electrically conductive alloy of any combination of the above. It can also be a metal compound such as cobalt oxide, ruthenium oxide, a tungsten carbide, a tungsten carbide cobalt, a stainless steel, or combinations thereof. It can further be a non-metal conductive material such as graphite, a graphite-doped ceramic, and a conducting polymer (e.g., polyaniline). In some embodiments the electrode lead for the anode and/or cathode is a piece of stainless steel wire rope. The electrode lead can be fastened to solid rods (which can be any material listed above, including also stainless steel), which rods can act as the conductors out of the top of the anode and/or cathode.

### Villiated Extensions

The high surface area electrode of the invention can comprise villiated extensions attached to the backing. The villiated extensions can be comprised of any appropriate electroconductive material, e.g., any of the electroconductive materials described herein. Examples include, but are not limited to, graphite, graphite-doped ceramic, a conducting polymer (e.g., polyaniline), steel, titanium, copper, gold, platinum, palladium, cobalt, manganese, or any combinations of any of them. For example, an electrode can be comprised of MnO₂-coated graphite.

The villiated extensions can take various forms, and in various embodiments comprise fibers, conductive fiber tows, groups of small gauge flexible wires, filaments, threads, yarns, piles, or can be coated or deposited with carbon nanotubules or a metal compound. Together the villiated extensions can have the appearance like a portion of a brush. The villiated extensions can be threaded, tied, punched, looped, knotted through, or otherwise attached to the electrode backing, which in various embodiment is a conductive mesh, woven backing, or grating. In various embodiments the villiated extensions can be solid, hollow, semi-permeable, or porous. Micro-pores or spaces present within the villiated extensions comprised of some materials can be filled with a suitable electroconductive material to enhance catalytic or conductive properties, but can also remain free space. In other embodiments the villiated extensions can also feature branches, nodules, coatings, or other designs to increase the surface area of the extensions. These structures can also be filled or coated with an electroconductive material. The villiated extensions can be sized to any appropriate scale to accommodate the particular application. In different embodiments the villiated extensions are graphite fibers or carbon nanotubules but in other embodiments the villiated extensions are stranded cables. When the villiated extensions are graphite fibers, they can be derived from a graphite fiber cloth or from a single strand of continuous graphite tow. The graphite cloth is comprised of groups or bundles of graphite fibers that are woven together to form a cloth. A tow represents a group or bundle of fibers and in various embodiments can contain about 3,000 or about 5,000 or about 10,000 or about 12,000 graphite fibers or greater than 12,000 graphite fibers. Typically the graphite cloth contains about 3 tows/sq-cm (or about 21 tows/sq-in).

The villiated extensions provide a high surface area surface for the growth of microorganisms on the electrodes. The microorganisms can grow directly on the electrode and be a part of a biofilm that forms thereon, and grow within the biofilm. As microorganisms oxidize the substrate provided to the anode compartment, the electrons released will be provided to the anode and flow to the cathode. An electric current will therefore form flowing between the anode to the cathode. In the cathode compartment there is present the cathode. In some embodiments the cathode compartment contains oxygen and electrons flowing to the cathode will combine with the oxygen to form water. In one embodiment the water in the cathode compartment is aerated to provide oxygen to the cathode.

The villiated extensions utilized in the electrodes of the invention can have a length and width or circumference suitable to the application. In various embodiments the villiated extensions of the invention have a length of at least 4 cm or at least 5 cm or at least 6 cm or at least 8 cm or 4-8 cm or 4-15 cm or 4-20 cm or 4-50 cm. The villiated extensions can have a width of at least 2 um or at least 5 um or about 7 um or at least 10 um or 2-10 um or 2-20 um or 2-50 um. The precise measurements will depend on the material chosen and the process by which it was manufactured.

In some embodiments, particularly in larger applications, the electrode and/or cathode villi can be comprised of strips of material, which can have a length of at least 10 cm or 15 least 13 cm or at least 15 cm or at least 17 cm or at least 20 cm or 10-15 cm or 12-17 cm or 15-20 cm. The strips can have a width of 1-2 cm or 2-3 cm or 3-4 cm or 3-5 cm or larger than 5 cm depending on the size of the electrodes used in the application. Convenient numbers of such strips associated with each anode and cathode can be about 500 or about 750 or about 1000 or about 1500 or more than 500 or more than 750 or more than 1000 or more than 1500.

In one embodiment the villiated extensions can be comprised of an alloy of two metals. In a particular embodiment the villiated extensions are comprised of graphite fibers, and can be comprised of only graphite and/or graphite fibers. In another embodiment the villiated extensions are carbon nanotubules. But in other embodiments the villiated extensions can be comprised of metal compounds, or non-metal material, or of any electroconductive material. Examples of electroconductive materials are provided herein.

In one embodiment the villiated extensions are comprised entirely of an electroconductive material, and no portion of the villiated extension is comprised of a non-conductive material. It was discovered that distinct advantages can be achieved using this design rather than by providing a material comprised of a non-conductive or poorly conductive material and filling it with a conductive material. When the electrode is constructed entirely of an electroconductive material according to the present invention there is a significant decrease in resistivity and increase in power density, thus improving the efficiency of the conduction of electrical current through the electrode. It was also discovered that advantages can be obtained by constructing the electrodes and/or villiated extensions so that they are free of binders, resins, sealants, and any other material that may impart electrical resistance. Thus, in various embodiments the electrodes and/or villiated extensions of the invention are constructed without using materials such as nylons, polyesters, polypropylene, silicons, or other textile fibers. When the material selected for the electrodes is graphite this is problematic as commercially available graphite contains residues of these materials. Thus, the present inventors discovered that by removing these materials, for example through a chemical treatment or heat treatment process, a significant decrease in resistivity and increase in power density is obtainable. Such methods are further described herein.

### Insulating Substances

Thus, in one embodiment the villiated extensions are substantially free of insulating substances. By “substantially free” is meant that a residue of less than 1 wt % of aluminum, oxides, or silicon is present on the villiated extensions. Without wanting to be bound by any particular theory, the present inventors believe that in the process of manufacturing the various conductive materials that can be used to form the villiated extensions there remains on the material a residue of insulating substances from the manufacturing process. These insulating substances may variously be industrial lubricants or coating materials. In some cases a residue of these lubricants is left on the material as a result of molding, pultrusion, or compositing processes utilized in the manufacture of these materials, but in other cases by various other aspects of the manufacturing process. These residues can be electrically insulating, and therefore increase the resistivity of the material used to form the villiated extensions or other components of the electrode. The residue of the insulating substances can also have the effect of filling microscopic cavities on the conductive material and thus decrease the surface area that microbes have to colonize, or can provide a residue or coating that blocks the microbes from accessing the conductive material, thus impeding their ability to transfer electrons to the surface and respire. When these insulating substances are removed from the material used to make the villiated extensions or other electrode components, a substantial increase in current flow and power density is realized.

These insulating substances can be comprised of any insulating substance but in various different embodiments are comprised of aluminum, or silicon, or oxides. A substance is an insulating substance when it has a conductivity of less than 10⁻⁸ (ten to the minus eighth power) siemens per cm at 25° C. In other embodiments an insulating substance or non-conducting material has a conductivity of less than 10⁻³ siemens per cm at 25° C. or less than 10⁻² siemens per cm at 25° C. A material is a conductive material when it has a conductivity of greater than 10⁻² siemens per cm at 25° C. or greater than 1 siemen per cm at 25° C. or greater than 10³ siemens per cm at 25° C.

### Microbial Fuel Cell

The basic design of a two-compartment microbial fuel cell contains an anode in an anode compartment, a cathode in a cathode compartment, and a cation or anion exchange membrane (or proton exchange membrane) separating the two compartments. An electrical circuit is present between the anode electrode and the cathode electrode. The electrical circuit is generated by providing an oxidizable substrate to microorganisms present on the anode, which convert the substrate into CO₂, protons, and electrons. Under anaerobic conditions the liberated electrons are provided to an electron acceptor on the anode, either directly from the bacteria or through a mediator that carries the electrons, and electrons flow from the anode to the cathode. At the cathode, the electrons are provided to an electron acceptor, usually oxygen. The difference in electric potential between the anode and the cathode results in the generation of electrical power. The MFCs of the invention can function with or without mediators. In embodiments utilizing a mediator, the mediator can be any suitable mediator such as, for example, thionine, anthraquinone-2,6-disulfonate, humic acids, 2-hydroxyl-1,4-naphthoquinone and soluble quinones, or neutral red.

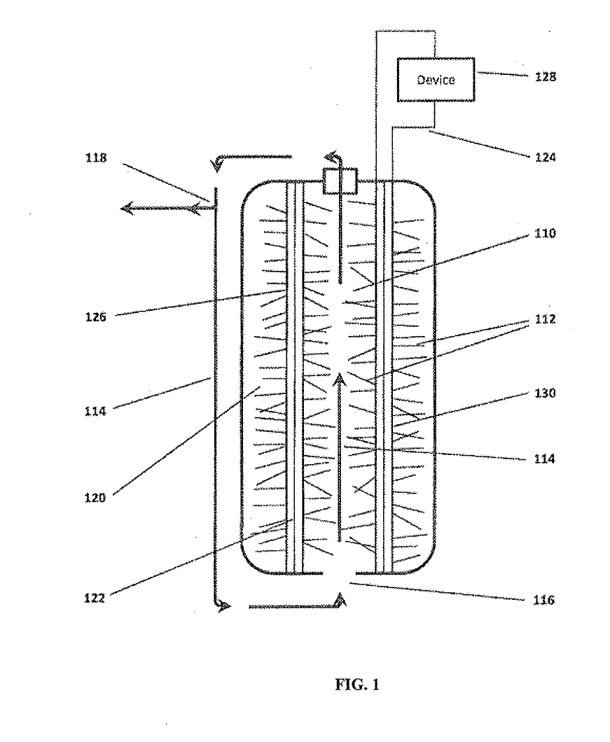

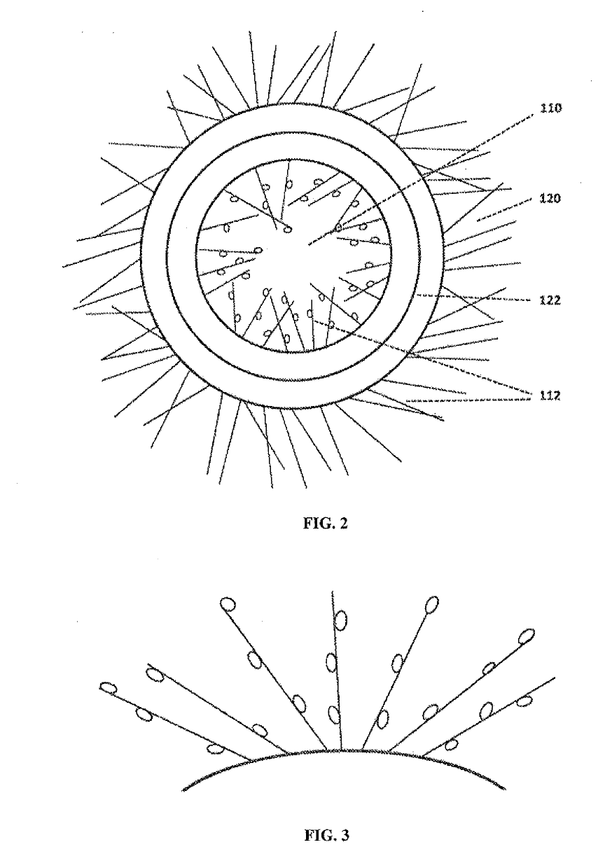

The microbial fuel cells of the present invention can be utilized in a variety of fowls. In one embodiment the MFC is a two-compartment MFC with the anode comprised in an anode compartment and the cathode comprised in a cathode compartment. With reference to FIG. 1, an embodiment of a two-compartment microbial fuel cell of the invention utilizing a columnar design is depicted. The anode compartment 110 contains the anode. In this embodiment anode contains villiated extensions 112 that extend from the mesh electrode backing of the anode 130. The villiated extensions 112 have the form of fibers or villi and provide a surface area for colonization by microorganisms, which oxidize an oxidizable substrate and provide the electrons liberated to the anode. In this embodiment the anode is curved to form a generally circular configuration so that the villiated extensions project inward into the anode compartment 110. The cathode can also comprises a mesh electrode backing 126 and can also comprise villiated extensions that extend from the mesh electrode backing of the cathode 126. FIG. 2 presents a cross-section of the microbial fuel cell of FIG. 1, also illustrating the villiated extensions 112. In other embodiments the cathode can have the same design and can also have villiated extensions.

In this embodiment the oxidizable substrate is contained in wastewater, which flows along a flow path 114 through the anode. In this embodiment the flow path 114 flows in through the bottom of the microbial fuel cell, through the anode, and out through the top of the microbial fuel cell. In another embodiment the flow path can flow in through the top of the MFC, through the anode, and out through the bottom of the MFC. In some embodiments the flow path can then be looped around the microbial fuel cell and re-enter through the inlet 116, thus repeating the flow path. When the wastewater has been treated sufficiently, for example as evidenced by reaching a goal for BOD or COD values, the wastewater can be diverted from the microbial fuel cell by a valve 118, which diverts the remediated wastewater to an appropriate reservoir for disposal or further treatment.

The microbial fuel cell also has a cathode compartment 120. The cathode compartment contains a cathode, which can also have fibers or villi 112, and which also can be colonized by microorganisms. The cathode can also be largely abiotic. In this tubular design the cathode is bent into a generally circular configuration so that the villiated extensions project outward from the backing and into the cathode compartment 120. The cathode compartment can surround the anode compartment along at least one axis, which is illustrated in FIG. 2 where the cathode surrounds the anode along a vertical axis. The anode compartment 110 and the cathode compartment 120 are separated in this embodiment by an oxygen barrier 122, which prevents or minimizes oxygen flowing from the cathode compartment into the anode compartment, but in other embodiments can be separated by any proton exchange membrane or any separator (e.g., those described herein). This design allows the anode and the cathode to be separated by very small distances, such that the anode and the cathode can be within 1 cm of each other or within 1 mm or within 100 micrometers of each other. The anode and cathode are connected by an electrically conductive path 124 provided by an electroconductive material, allowing the flow of electrons from the anode to the cathode. The electrically conductive path 124 can flow through a device 128 for any useful purpose, such as to be powered by the electrical current, or to harvest and store the current produced for use of the electricity generated at a later time.

With reference to FIG. 2, a cross-section of the microbial fuel cell of FIG. 1 is depicted. In this embodiment the anode 110 is comprised in a generally circular form and is contained within a cathode 120 or comprised interior to the cathode. The cathode is comprised in a generally circular fowl surrounding the anode 110 along one or more axes, for example the vertical axis. Both the anode 110 and the cathode 120 in this embodiment contain villiated extensions 112, as described herein. This embodiment also contains an oxygen barrier membrane 122, as described herein.

Yet another advantage of the MFC of the present invention is that it does not utilize a polymer binder or seal in any portion of the electrode design. Such polymer (e.g., silicon-based epoxy) binders or sealers are often used in electrodes to prevent leakage or to connect portions of an electrode to a microbial fuel cell. But these polymer binders often increase resistivity. The present invention provides a design that eliminates any need for such binders or sealers to interface the electrodes with the conductive leads. In another embodiment the microbial fuel cells of the invention have an open circuit potential (OCP) of at least 100 mV or at least 200 mV or at least 400 mV or at least 600 mV or at least 800 mV or at least 900 mV. In other embodiments the OCP is between 100 mV and 900 mV.

In one embodiment the anode chamber (and/or cathode chamber) is configured for substantially linear flow of liquid through the anode. By substantially linear flow is meant that the center of the flow path of liquid from the entrance to the anode to the exit from the anode is less than 30 degrees, or less than 20 degrees or less than 10 degrees. In various embodiments the liquid flow rate through the anode is at least 5 L/h or at least 50 L/h or at least 200 L/h. But in other embodiments the flow rate can be at least 300 L/h or at least 400 L/h or at least 500 L/h or 5-50 L/h or 5-100 L/h or 100-200 L/h or 300-600 L/h. In another embodiment the anode chamber and/or cathode chamber are configured for unobstructed flow, meaning that no structures are present between some area of the inlet and outlet of the anode and/or cathode compartment, respectively. Thus, a clear path can be traced from some area of the inlet to some area of the outlet, unobstructed by structural components of the MFC.

The present invention thus offers a high surface area electrode without the problems of impeded flow and clogging encountered with granule-packed beds or the greater weight introduced by porous conductive plates. In the event that clogging does occur with an MFC of the present invention it is easily and quickly resolved through backflushing of the MFC. The MFC of the present invention also allows for the processing of high fluid flow rates of wastewater or other liquid to be treated without problems of clogging, and without the need for frequent utilization of backflow procedures to unclog membranes and electrodes. Furthermore, the MFCs of the invention allow for the processing and remediation of viscous fluids that cannot be processed or remediated with previously available MFC designs. The MFCs of the present invention also offer a dramatic reduction in the weight of the apparatus. In one embodiment the weight of the MFC of the present invention is less than 20% or less than 15% or less than 10% or less than 8% the weight of a fixed, granule-packed-bed electrode that occupies the same volume, while still providing the same or greater surface area available for colonization by microorganisms that oxidize an oxidizable substrate. The MFCs of the present invention can also be easily scaled to large or small applications. In various embodiments the MFCs of the present invention can have an anode compartment having a volume of at least 10 cm³ or at least 100 cm³ or at least 1 m³ or much greater volumes (e.g., see Example 6). In various embodiments the anode volume can be 1-100 m³ or 100-1000 m³ or about 500-1500 m³ or 3,000-5,000 m³ or about 10,000 m³ or 5,000-15,000 m³. In various embodiments the anode and cathode volume, either together or individually, can be more than 10 L or more than 25 L or more than 50 L or more than 75 L or more than 100 L or more than 250 L or more than 500 L. The volume of the anode can be adapted to the application of the MFC. In the same way the volume of the cathode compartment can be at least 10 cm³ or at least 100 cm³ or at least 1 m³ or a much greater volume as illustrated in Example 6. In general it is desirable to have a cathode surface area of at least 2× that of the anode surface area. The MFC of the invention can operate under continuous flow, or in sequence batch mode, or in batch mode.

In different embodiments the MFC of the invention can have a submerged anode (submerged in the fluid in the anode compartment), and/or a submerged cathode, to prevent drying or fouling of the anode and/or cathode. In one embodiment both the anode is submerged in the anode compartment and the cathode is submerged in the cathode compartment. In other embodiments the anode is submerged and the cathode is not.

Thus, in one embodiment the microbial fuel cell of the invention utilizes a two-chamber configuration, meaning that the fuel cell has an anodic chamber and a cathodic chamber as separate compartments that do not communicate to exchange liquid (e.g. wastewater), and the anodic chamber and cathodic chamber are separated by a membrane or barrier (e.g., a proton exchange membrane) to prevent or minimize diffusion of oxygen into the anodic chamber. In one embodiment the microbial fuel cell utilizes an oxygen barrier that separates the anodic and cathodic compartments and is not a cation or anion exchange membrane, and is not a proton exchange membrane.

The microbial fuel cells of the invention can also be constructed using a flat plate design. Thus, the villiated extensions can be comprised on flat plates that face each other or face away from each other. When flat plates are used to comprise the villiated extensions they can be configured so that the distance between the anode and the cathode are minimized to decrease the overall internal resistance of the system.

### MFC Parameters

The fluid to be treated can be any fluid containing an oxidizable substrate. In one embodiment the fluid to be treated is industrial wastewater. The fluid to be treated can have an initial chemical oxygen demand (COD) of greater than 300 mg/L or greater than 600 mg/L or greater than 1200 mg/L or greater than 2400 mg/L or greater than 4800 mg/L or 250-750 mg/L or 1,000-1,500 mg/L or 2,000-3,000 mg/L or 4,000-6,000 mg/L. The actual beginning level of COD in the fluid to be treated will depend on the nature of the fluid and the nature and level of contaminating substances in the fluid. The microbial fuel cells of the invention are effective for the lowering of COD from fluid to be treated. In one embodiment the fluid to be treated is industrial wastewater. In different embodiments the microbial fuel cells of the invention lower COD by at least 60% or by at least 70% or by at least 80% or by at least 90% from the starting level of COD in the fluid to be treated. In various embodiments the COD is lowered to less than 350 mg/L, or less than 200 mg/L, or less than 100 mg/L, or less than 60 mg/L, or less than 50 mg/L in the treated fluid. In various embodiments the COD removal rate is at least 50 g/m³-day or at least 100 g/m³-day or at least 500 g/m³-day or at least 750 g/m³-day or at least 1000 g/m³-day.

The MFCs of the invention are also effective for the lowering of total suspended solids (TSS) from fluid to be treated. In different embodiments the microbial fuel cells of the invention lower TSS by at least 50% or by at least 60% or by at least 70% or by at least 80% from the starting level of TSS in the fluid to be treated. The MFCs of the invention are also effective in lowering the biological oxygen demand (BOD) in the fluid to be treated. In different embodiments the BOD is lowered to less than 350 mg/L or less than 200 mg/L or less than 100 mg/L or less than 80 mg/L or less than 60 mg/L or less than 50 mg/L or less than 40 mg/L in the treated fluid.

The MFCs of the invention are also useful in the recovery of energy from fluid to be treated. The amount of energy generated by the MFCs will be dependent on different factors such as, for example, the open circuit potential at the anode, the amount and type of bacterial cells present on the anode, the resistance of the conductive material carrying current from the anode to the cathode, the amount and types of contaminants in the water being treated, and the oxygen barrier or proton exchange membrane used. When the fluid to be treated is industrial wastewater the MFCs of the invention, in various embodiments, recover at least 15% or at least 20% or at least 30% or at least 40% or 15-30% or 15-50% or 15-75% of the energy contained in the water. In various embodiments the MFCs of the invention can generate power at the rate of at least 0.5 kW/m³ or at least 0.8 kW/m³ or at least 1.0 kW/m³ or >2 kW/m³. The MFCs of the invention generate electrical current. The precise amount of current generated will depend on the number of microorganisms present, the activity of the microorganisms that are generating electrons as well as the surface area of the anode. In various embodiments the MFCs of the invention can generate a current density of greater than 5 A/m² or greater than 8 A/m², or greater than 10 A/m².

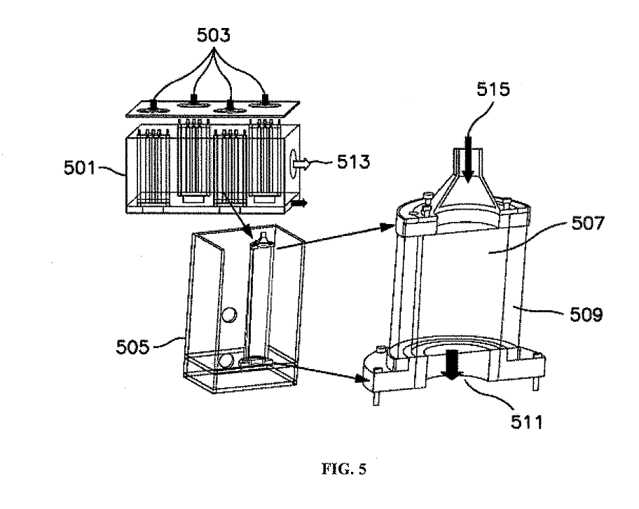

The MFCs of the invention can also be comprised in tandem to form a module of microbial fuel cells. A module is a plurality of MFCs, which can operate in parallel or have a passageway connecting the anode compartments of one or more MFCs. An example module is depicted in FIG. 5. In FIG. 5 a module 501 containing multiple MFCs is depicted. The module 501 has multiple inlet openings 503 and can have one or more openings for outflow 513. A single MFC 505 is shown isolated from the module, which has an anode compartment 507 and a cathode compartment 509. The single MFC has an inlet opening 515 and an outflow opening 511. A module treats the wastewater more rapidly and also allows for the treatment of larger volumes. The MFCs of the invention are scalable in any format, whether columnal supports are used to comprise the villiated extensions on the anode or whether plates are used. In any format the MFCs of the invention are scalable to meet the needs of any volume of fluid to be treated that is being produced. Any of the electrodes or MFC designs described herein can be used in the modules of the invention.

### Heat/Chemical Treatments and Removal of Lubricants/Coatings

In another embodiment the invention is a microbial fuel cell having a chemically-treated anode and/or cathode. The MFC can also have a heat-treated cathode. The anode and cathode can be any described herein. Chemical treatment or heat treatment of the electrode(s) may be used to remove the insulating coating materials, lubricants, or other insulating substance(s) sometimes deposited during the manufacturing process. By “chemically-treated” is meant that the anode has been exposed to a chemical for at least 6 hours. But in other embodiments the chemical treatment can involve exposing the electrode to a chemical for least 1 hour, or at least 3 hours, or at least 9 hours, or at least 12 hours prior to the use as an electrode. The specific time period will vary depending on the chemical used and its strength. In different embodiments the chemical is a chemical not typically found in wastewaters in higher than trace amounts, and excludes a chemical that is simply used as a buffer. The chemical treatment can also result in a change in the conductivity of the electroconductive material that comprises the villiated extensions or electrode backing. In one embodiment the chemical is acetone (e.g., at least 90% acetone or 100% acetone) but in other embodiments the chemical can be 0.1 N NaOH or 1 N NaOH or any base. In other embodiments the chemical can be an acid such as concentrated hydrochloric or sulfuric acid. And in additional embodiments the chemical can be ammonium peroxydisulfate. But any chemical that has the effect of removing insulating substances from the conductive material can be applied in a chemical treatment of the invention.

By heat-treatment is meant that the cathode has been exposed to flame or to temperatures in excess of 200° C. for a period of at least 10 seconds or at least 15 seconds or at least 30 seconds or at least 45 seconds or at least 1 minute. In other embodiments the conductive material can be exposed to flame or heated to more than 300° C. or more than 400° C. or more than 500° C. or more than 800° C. or more than 1000° C. or more than 1200° C. or more than 1500° C. for periods of time of at least 15 seconds or at least 30 seconds or at least 45 seconds, or periods of about a minute or more than 1 minute. If lower temperatures are used then generally a longer amount of time will be desirable, whereas if the higher temperatures are used the treatment time can be as short as 15-30 seconds or less than 1 minute.

### Microbes

A variety of microorganisms are known to be suitable for use in microbial fuel cells. In one embodiment the microorganisms are electrogenic bacteria. Non-limiting examples of bacteria that can be used in the present invention include, but are not limited to, Rhodoferax ferrireducens, Shewanella spp., Shewanella putrafaciens, Geobacter spp., Geobacter metallireducens, Geobacter sulfurreducens, Proteobacter spp., delta-Proteobacter, Vibrio spp., Pseudoalteromonas spp., Aeromonas hydrophila, Escherichia coli, Enterococcus faecium, Clostridium butyricum, and Desulfovibrio desulfuricans. While normally mixed cultures will be used on the electrodes, in some embodiments pure microbial cultures are used. The microorganisms can be inoculated onto the anode and/or cathode, or they can be allowed to grow naturally after exposure of the anode to wastewater or other fluid to be treated by the MFC.

### Membraneless/Oxygen Barrier

Conventional microbial fuel cells utilize a proton exchange membrane (PEM) between the anode compartment and the cathode compartment. PEMs are semipermeable membranes, generally made from ionomers and allow the passage of protons while having low permeability to gases such as oxygen or hydrogen. In one embodiment the present invention utilizes a proton exchange membrane (or a cation or anion exchange membrane in some embodiments). But the present invention provides the additional advantage in some embodiments of utilizing an oxygen barrier that is not a proton exchange membrane (and not a cation or anion exchange membrane), thus eliminating the membrane and significantly reducing the costs of creating and operating a microbial fuel cell. Without wanting to be bound by any particular theory, the present inventors discovered that the use of PEM (or cation or anion exchange) membranes does not provide a benefit that correlates with their high cost, and discovered that a membrane could be removed and replaced with an oxygen barrier, resulting in a far more cost efficient apparatus without a significantly negative impact on the result achieved. Thus, in one embodiment the present invention utilizes an oxygen barrier membrane that is not a proton exchange membrane and is not a cation or anion exchange membrane. In this respect the MFC of the present invention can be a truly membraneless MFC. In one embodiment the membrane or separator utilized in the present invention to separate the anode and the cathode is not a functionalized membrane or is not a chemically treated membrane, meaning that it is not specific to the passage of cations or anions. The membrane or separator can be a porous, non-conductive insulator. In one embodiment the separator or membrane does not allow for the passage of an amount of oxygen that reduces the potential between the anode and the cathode more than about 10% or more than about 5% compared to the MFC with a PEM (or cation or anion exchange) membrane. In one embodiment the oxygen barrier membrane utilized in the invention is a polydimethyl siloxane (PDMS) membrane. In other embodiments the oxygen barrier membrane can be made of nylon, polyester, cellulose, or another suitable base material, but is coated with PDMS or Polytetrafluoroethylene (PTFE) (TEFLON®, E.I. Dupont de Nemours, Wilmington, Del.), or sulfonated tetrafluoro ethylene-based fluoro-polymer copolymer, or another suitable membrane material that provides an oxygen barrier character.

The membraneless fuel cell can be a two-compartment fuel cell having an anode compartment and a cathode compartment. In one embodiment there is little to no fluid communication between the anode compartment and cathode compartment.

In some embodiments the anode and cathode can be separated by an HDPE rigid mesh tulle wrapped with a PVDF ultra-filtration membrane having an appropriate rejection threshold (e.g., 50 kDA, about 75 kDa, about 85 kDa about 100 kDa). The separation can be sealed with an appropriate substance, for example a urethane fast hardening epoxy.

### Packed Bed

In some embodiments the microbial fuel cells of the invention utilize a packed bed. The packed bed microbial fuel cell provides the advantage of a much greater surface area for microbes to colonize and to interact with the water to be treated. In one embodiment the microbial fuel cell of the invention utilizes a packed bed anode. The electrode bed can be packed with granules of carbon, graphite, or any conductive material. But in other embodiments the anode is packed with objects of various shapes that comprise villiated extensions on one or more surfaces. In one embodiment the objects have a generally spherical shape and the exteriors of the objects have villiated extensions thereon, but objects of any shape can be utilized, such as square objects, pentagonally or octagonally shaped objects, or objects having any number of flat or round surfaces. In a particular embodiment the objects are ping pang balls, or generally have the shape of ping pang balls, and the surfaces thereof contain or are covered with villiated extensions, as described herein. But various types of objects can be utilized in the invention. For example, small plastic golf balls commonly used for practice, or other small plastic balls commonly known as WIFFLE® balls (Wiffle Ball Inc., Shelton, Conn.) may be utilized. Small plastic practice golf balls are advantageous in that their smaller size enables a larger number of them to be contained in the electrode, but any type of small plastic spheres or balls can be used. In one embodiment the surfaces of the objects have holes or openings in them allowing the passage of liquid into the interiors and the interiors of the objects, and the interior and/or exterior surfaces can also contain or be covered with villiated extensions. Of course small plastic objects of generally spherical shape and having holes or openings in their surfaces can be manufactured for these purposes. In these embodiments water to be treated will pass through the interior of the object and interact with the villiated extensions on the exterior and/or interior of the objects. The interiors of the objects can be coated with villiated extensions during the manufacturing process and prior to being made into a whole sphere. This can be conveniently done by gluing, adhering, threading, sewing, or otherwise attaching or connecting the villiated extensions to the interiors and/or exteriors of the objects. In some embodiments epoxy or another suitable adhesive material is used, but in other embodiments no adhesive is used and the villiated extensions are attached by threading, sewing, or otherwise attaching the villiated extension to the surface. The objects can be conveniently made of plastic or any suitable base material. Plastic and other strong but light materials have the advantage of providing a packed bed that is very light. In various embodiments the packed bed will have a total surface area of greater than 1 sq. meter (m²).

### Production Techniques

A variety of materials from various common commercial sources can be utilized as resources to obtain the materials used in the present invention. The electrodes and villiated extensions of the invention can be manufactured using various technologies. When the material used to form the villiated electrodes is graphite or graphite fibers, this is readily available from commercial suppliers and is normally made using tufted carpet technologies or adapted from technologies for the production of conductive pile and backing materials on automated machinery.

### Example 1

### Acetone Treatment of Conductive Material

Chemical treatment of the electrodes was performed as follows: graphite fibers to be used in the manufacture of an electrode were placed in 100% acetone and gently agitated on a rocker table overnight for about 12 hours. The fibers were then thoroughly rinsed with deionized water and stored in deionized water until their use.

In an alternate procedure the fibers were placed in 1 N NaOH for the same period of time and otherwise treated the same as described above.

### Example 2

### Heat Treatment of Conductive Material

In an alternate procedure the graphite fibers were heat treated prior to being used in the manufacture of an electrode. The graphite fibers were held in the hottest part of a Bunsen burner flame (approx. 900° C.) for 1 minute until all fibers reached an orange hot state. These fibers were then used in the manufacture of an electrode.

### Example 3

### Measurements of Fuel Cells Using Pre-Treated Anode

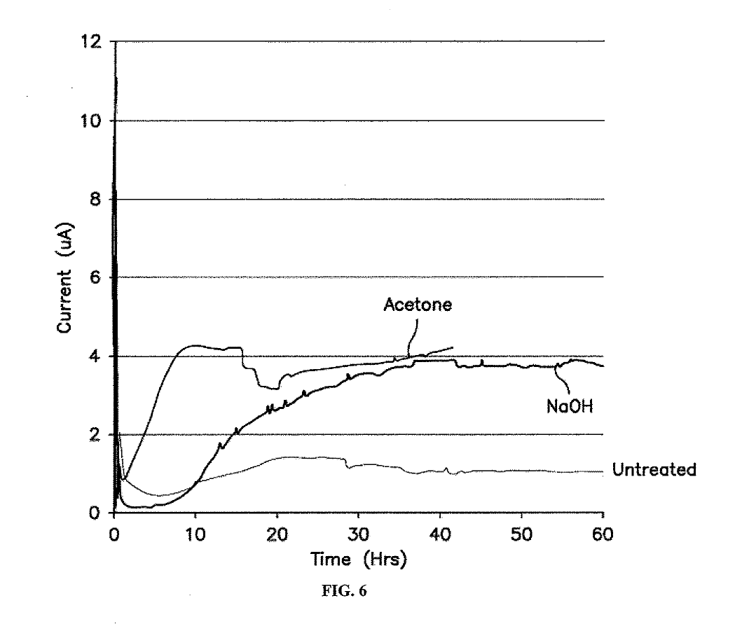

Different microbial fuel cells were constructed using graphite fibers at the anode that had been 1) heat treated according to Example 2; 2) chemically-treated with acetone according to Example 1; and 3) untreated graphite fibers. The volume of the anode was 2 mL and the volume of the cathode was 5 mL. The cathode was a piece of graphite cloth with a gas diffusion layer of PTFE and an active Pt catalyst with a sulfonated tetrafluoroethyene-based fluoropolymer-copolymer (NAFION®, E.I. du Pont de Nemours, Wilmington Del.) binder on the side facing the solution. No stainless steel backing was used. The cathode was not treated in either embodiment. The anode was a 6 cm length of a single tow of graphite fibers (12,000 individual fibers), which equated to a surface area of 131.5 cm². The MFC was operated under continuous flow with 60 mM of lactate as the substrate (fuel) and Shewanella oneidensis MR-1 as the biocatalyst. Current was measured between the anode and the cathode over time. FIG. 6 shows that within a short time of beginning the experiment a much higher current was measured in the fuel cell having the villiated (graphite fiber) extensions at the anode that were chemically-treated with acetone according to Example 1 versus the MFC having the villiated extensions that were untreated. The MFC having an anode with villiated (graphite fiber) extensions treated with NaOH according to Example 1 also gave a significantly higher current than an MFC having an anode with untreated villiated (graphite fiber) extensions.

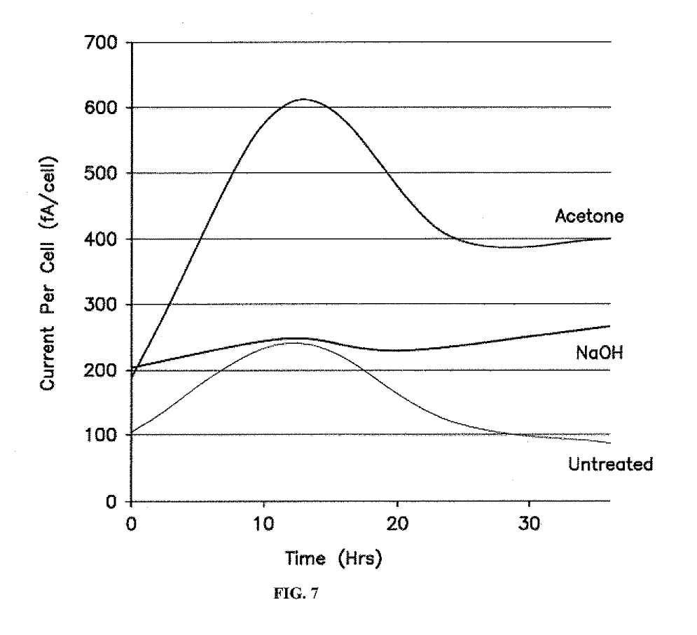

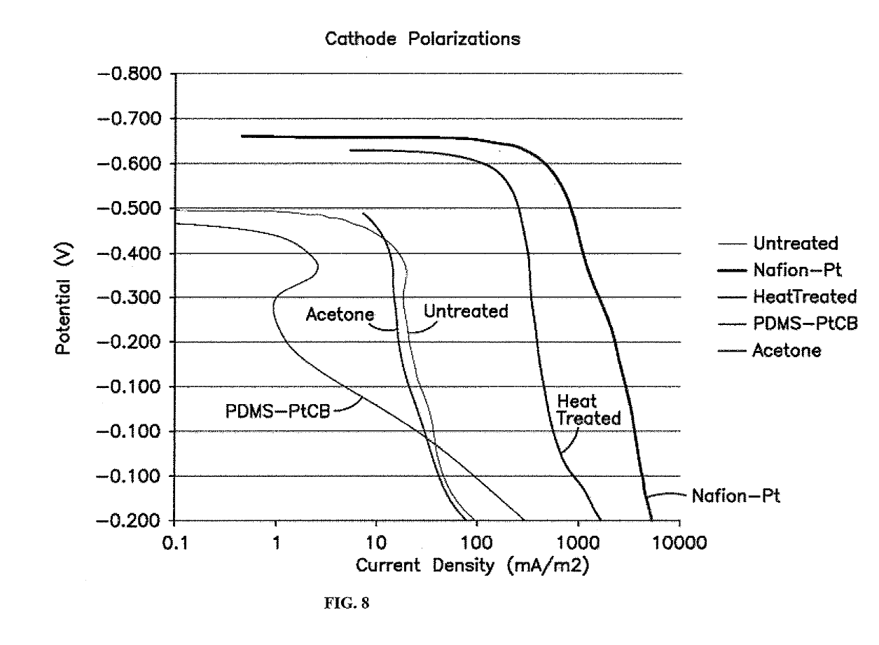

In order to measure whether the increase in current might be due to a difference in microbial populations on the anode measurement of current at the anode was taken on a per cell basis. FIG. 7 illustrates that when measured on a per cell basis the MFC having an anode with chemically-treated graphite fibers (with acetone or NaOH) according to Example 1 showed significantly higher generation of electric current compared to a fuel cell using an anode comprised of untreated material.

Chemically-treated anode/Heat-treated cathode: Another MFC was constructed of the same dimensions as above using an electrode backing made of a stainless steel mesh with graphite tows sewn into the backing as villiated extensions to form the anode. The electrode backing had an area of 0.056 sq. meters (or 560 cm²) and a tow density of 7,000 tows/sq-m. The graphite tows used to form villiated extensions on the anode were chemically treated with acetone according to Example 1. The cathode was made of a stainless steel mesh using graphite tows that had been heat-treated according to Example 1. Wastewater having a COD of 6830 mg/L was flowed into the anode at a flow rate of 50 mL/min for 24 hours. At the end of the time period the COD had been reduced to 2910 mg/L for the system that had a chemically treated anode electrode. This compared to a COD reduction to only 3980 mg/L for the MEC using a heat-treated or untreated anode. All systems used a heat-treated cathode, as described above.

### Example 4

### Construction of an Anode and Cathode

An anode for use in the invention was constructed by obtaining a graphite weave or mesh from commercial sources. After acetone treatment of the weave or mesh according to Example 1, tows (bundles of fibers) were pulled out of the weave and then sewn back into an intact weave to form an electrode backing with villiated extensions. When a large number of tows were sewn into the weave, there was obtained an electrode backing having a large number of villiated extensions. This was utilized as the anode. In an alternative embodiment the tows were sewn into or attached to a stainless steel mesh backing.

### Example 5

### Brewery Wastewater Remediation

An MFC was assembled having an anode having an electrode backing made of stainless steel mesh with graphite fiber villiated extensions attached thereto. The area of the electrode backing was 0.083 sq meters and the number of 20 cm long graphite fiber tows used to make the villiated extensions was about 2,090 (2.5×10⁷ fibers/m²). The villiated anode had a surface area of 220 sq-m. The anode was configured into a generally circular configuration generally similar to that depicted in FIGS. 1, 2, and 4. The total liquid volume of the anode was approximately 4 L. A cathode was configured to surround the anode in at least one plane, again similar to the configuration depicted in the figures. The cathode was made of packed-bed graphite granules (¼″×10 crush) and had a surface area of 439 sq-m. Air was bubbled through the cathode to provide oxygen. Wastewater from a brewery was pumped through the anode compartment and the wastewater was initially measured as having a COD of 5800 mg/L. The anode was not specifically inoculated but was allowed to self-inoculate with microorganisms present in the wastewater. The wastewater was pumped through the anode compartment at a rate of 100 mL/min and re-cycled into the entrance to the anode. The conductive path connecting the anode to the cathode was routed through a 500 ohm resistor for the purpose of measuring electrical energy. The MFC was allowed to run for a period of 96 hours, at which point the COD had been reduced to 1630 mg/L. This was compared to a conventional MFC utilizing a packed bed configuration, which reduced the COD to only 3320 mg/L after 96 hours.

### Example 6

This example illustrates MFCs that can be constructed according to the principles described herein, using a stainless steel (SS) electrode backing or a graphite cloth (GC) electrode backing at the anode, in both cases utilizing graphite fibers attached to the electrode backing. Examples of MFCs for widely varying sizes are constructed according to Table 1. Thus, in various embodiments the MFC of the invention having a graphite cloth (GC) backing has a ratio of total anode surface area (SA) in square meters to anode volume in cubic meters of at least 1.0×10⁵ (m²/m³) or at least 5.0×10⁵ (m²/m³) or at least 1.0×10⁶ (m²/m³) or at least 1.0×10⁶ (m²/m³) or at least 2.0×10⁶ (m²/m³) or at least 2.9×10⁶ (m²/m³). This compares to a typical MFC utilizing ¼ inch×10 crush graphite granules, which would have a ratio of 6.24×104 m²/m³.

Table 1 measurements assume an MFC of 6 m in height by 0.13 m in diameter, a 0.4 m circumference and 0.06 m radius. The volume per MFC column is thus 0.08 m³ (or 21 gallons). The length of the anode tows used is 0.06 m with a tow spacing of 0.01 m at the anode. At the cathode the length of the tows is 0.10 m and the tow spacing is 0.01 m.

With respect to the surface area calculation for a GC electrode backing, the height of the electrode backing is 6 m and the width is 0.45 m, for a total SA of GC electrode backing of 567 m². The surface area (SA) of the villi in the anode is calculated assuming 23,939 tows used having a length of 0.06 m, thus correlating to a villi SA of 401 m².

For a stainless steel (SS) mesh electrode backing, the length is assumed to be 6 m and the width 0.45 m, for a total SS backing SA of 14 m².

The surface area of the GC fibers or SS mesh is calculated assuming a radius of (0.007/2) mm=0.0035 mm, based on an average fiber width of 7 um. h=height of tow used; n=number of fibers per tow (12,000). SA of the tow thus equals 2×pi×r×h×n=0.264 h-m² where h is in meters.

TABLE 1

| | | | | | | Total | | |
|---|---|---|---|---|---|---|---|---|
| | | | | | Total | anode | | |
| | | | | | anode | SA | SA/vol. | SA/vol. |
| | Anode | Anode | | # tows per | SA (m²) | (m²) | (m²/m³) | (m²/m³) |
| | vol. | vol. | # MFC | total anode | GC | SS | GC | SS |
| Application | (gal) | (m³) | columns | vol. | backing) | backing | backing | backing |
| Single | 264 | 1 | 13 | 314,961 | 2.99 × 10⁶ | 7.13 × 10⁴ | 2.99 × 10⁶ | 7.13 × 10⁴ |
| family | | | | | | | | |
| home | | | | | | | | |
| Multiple | 2,642 | 10 | 132 | 3,149,606 | 2.99 × 10⁷ | 7.13 × 10⁵ | 2.99 × 10⁶ | 7.13 × 10⁴ |
| family | | | | | | | | |
| units | | | | | | | | |
| Small | 26,417 | 100 | 1,316 | 31,496,063 | 2.99 × 10⁸ | 7.13 × 10⁶ | 2.99 × 10⁶ | 7.13 × 10⁴ |
| business | | | | | | | | |
| Large | 264,172 | 1000 | 13,157 | 314,960,630 | 2.99 × 10⁹ | 7.13 × 10⁷ | 2.99 × 10⁶ | 7.13 × 10⁴ |
| business | | | | | | | | |
| Small | 2.6 × 10⁶ | 10,000 | 131,568 | 3,149,606,299 | 2.99 × 10¹⁰ | 7.13 × 10⁸ | 2.99 × 10⁶ | 7.13 × 10⁴ |
| commty | | | | | | | | |
| City | 2.64 × 10⁷ | 100,000 | 1,315,683 | 31,496,062,992 | 2.99 × 10¹¹ | 7.13 × 10⁹ | 2.99 × 10⁶ | 7.13 × 10⁴ |

It will be readily apparent to one skilled in the art that varying substitutions and modifications may be made to the invention disclosed herein without departing from the scope and spirit of the invention.

All patents and publications mentioned in the specification are indicative of the levels of those skilled in the art to which the invention pertains.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed.

In addition, where features or aspects of the invention are described in terms of Markush groups, those skilled in the art will recognize that the invention is also thereby described in terms of any individual member or subgroup of members of the Markush group. For example, if X is described as selected from the group consisting of bromine, chlorine, and iodine, claims for X being bromine and claims for X being bromine and chlorine are fully described.

### Example 7

This example illustrates a larger scale version of a high surface area electrode of the invention.

The electrode consisted of four MFC columns with acetone treated villiated anodes and flame-treated villiated cathodes. The anode and cathode volume for each MFC was 77L. Anode and cathode electrode backings were constructed with a plain-weave graphite cloth having a density of 135 g/cm³, 673 micron thickness, and a weave count of 113×113 yarns/10 cm.

Electrode villi were made from a satin-weave graphite cloth have a density of 1.75 g/cm³, 890 micron thickness, and a weave count of 160×160 yarns/10 cm. The anode viii were 2.54 cm×15.00 cm strips and the cathode villi were 2.54 cm×30.50 cm strips of the satin-weave graphite cloth. Each villi strip was secured to the plain-weave cloth backing with corrosion resistant staples (2-3 staples per strip). There were approximately 1000 villi strips associated with each anode and cathode electrode yielding a surface area of 25 m² for the anode and 47 m² for the cathode.

The anodes were submerged in a bath of acetone overnight, rinsed with water, and allowed to dry completely before use. The cathodes were flame-treated with propane torches such that the surface of the cathode was exposed to flame for 30 seconds.

The leads for the anode and cathode consisted of twelve 335.28 cm pieces of 316 stainless steel wire rope (1×7 strands, 0.16 cm diameter) fastened to four 0.64 cm (Dia)×15.24 cm (L) 316 stainless steel solid rods, which act as the conductors out of the top of both the anode and cathode.

The anode and cathode chambers were separated by an HDPE rigid mesh tube (12.70 cm Dia×304.80 cm H,) wrapped with a PVDF ultrafiltration membrane with a 75 kDa rejection threshold and sealed with a two-part urethane fast-hardening epoxy. The ends of each anode frame were fitted with a 7.62 cm polycarbonate ring (12.70 cm OD×12.07 cm ID) for stability and strength at the edges. Each anode electrode was sealed to the rings at bottom and top of each tube to maintain a cylindrical fool).

The cathodes were wrapped around the ultrafiltration membrane and the electrode assembly was secured into a 25.40 cm (Dia)×304.80 cm (H) Schedule 40 PVC pipe. The full assembly was capped with custom fabricated HDPE caps (5.08 cm thick), which had water-tight electrical fittings for the leads, and barbed nylon or PVC fittings for liquid flow. The assembled columns were mounted onto powder-coated steel stands constructed from 0.64 cm thick steel plates.

The four MFC columns were configured so that the anodes could operate with parallel or series flow. The parallel configuration was designed for up flow through the anode and cathode. The anode was inoculated and fed with brewery wastewater (6,000 mg-COD/L). Inoculation required batch flow operation over a 5 day period. After a positive voltage was registered across a 1000 Ohm fixed load between the anode and cathode, the brewery waste was recycled through the system at a rate of 34.07 LPM (9 gpm) for a 7 day period. Fresh water with a dissolved oxygen content of 5-7 mg/L was recycled through the cathodes at a rate of 34.07 LPM (9 gpm).

The first inoculation with brewery wastewater resulted in a maximum treatment rate of 0.70 kg-COD/L/day. The second brewery wastewater sample was introduced after a high loading of yeast had been run in the system for over a week. The resulting treatment rates reflected a change in the anode community and slower treatment rates (0.30 kg-COD/L/day). Maximum operational voltage for each column reached ˜0.20 V (0.20 mA) after the first 48 hours and remained at this constant level for over 40 days, even though COD continued to decrease. The result may be attributable to the yeast remaining in the system and having an adverse effect on the bacterial community treatment rates, which could be resolved by a pre-treatment step to kill yeast in high yeast load samples or by using an RO membrane. However, the electrogenic community continued to recover energy at stable levels throughout each operation.

Other embodiments are within the following claims.

1. A high surface area electrode comprising:
an electrode lead and an electrode backing, wherein the electrode lead and the electrode backing are comprised of an electroconductive material, and the electrode backing comprises a mesh;
villiated extensions attached to the backing and comprised of an electroconductive material and providing a surface area for the growth of microorganisms and for transmitting an electric current.

2. A high surface area electrode according to claim 1 wherein the electrode lead and the electrode backing are comprised of
a metal selected from the group consisting of: titanium, platinum, gold, and an electrically conductive alloy of any two or more thereof; or
a metal compound selected from the group consisting of: cobalt oxide, ruthenium oxide, a tungsten carbide, a tungsten carbide cobalt, a stainless steel, and a conductive alloy of any two or more thereof; or
a non-metal conductive material selected from the group consisting of: graphite, graphite-doped ceramic, conducting polymer, and polyaniline.

3. A high surface area electrode according to claim 1, wherein the electrode lead and the electrode backing are comprised of the same electroconductive material.

4. A high surface area electrode according to claim 3, wherein the electrode lead is the electrode backing.

5. A high surface area electrode according to claim 1, wherein the villiated extensions are comprised entirely of an electroconductive material.

6. A high surface area electrode according to claim 5, wherein the villiated extensions are comprised of graphite.

7. A high surface area electrode according to claim 5, wherein the villiated extensions are comprised of a material selected from the group consisting of: graphite, graphite-doped ceramic, carbon, a conducting polymer, polyaniline, steel, titanium, copper, gold, platinum, palladium, or a combination of any two or more thereof.

8. A high surface area electrode according to claim 7, wherein the villiated extensions comprise carbon nanotubules.

9. A high surface area electrode according to claim 1, wherein the villiated extensions are conductive fibers having a form selected from the group consisting of: solid, hollow, semi-permeable, porous, nano-tubule, and branched.

10. A high surface area electrode according to claim 1, wherein the villiated extensions are chemically-treated or heat-treated.

11. A high surface area electrode according to claim 10, wherein the villiated extensions are substantially free of insulating substances.

12. A high surface area electrode according to claim 11, wherein the insulating substances comprise one or more substances selected from the group consisting of aluminum, silicon, and oxide.

13. The high surface area electrode according to claim 1, wherein the electrode is a packed bed anode and comprises a plurality of spherically shaped objects, and the spherically shaped objects comprise villiated extensions.

14. The high surface area electrode according to claim 13, wherein the villiated extensions are graphite fibers.

15. A microbial fuel cell comprising:
an anode comprised in an anode chamber, wherein the anode is suitable for supporting a bacterial population that oxidizes an oxidizable material and provides electrons to an electron acceptor on the anode;
a cathode comprised in a cathode chamber, wherein the cathode receives electrons from the anode;
an electrically conductive path connecting the anode in the anode chamber and the cathode in the cathode chamber; and
an oxygen barrier separating the anode chamber and the cathode chamber, wherein the oxygen barrier is not a cation or anion exchange membrane.

16. A microbial fuel cell according to claim 15, wherein the anode is a high surface area anode comprising:
an electrode lead and an electrode backing, wherein the electrode lead and the electrode backing are comprised of an electroconductive material, and the electrode backing comprises a mesh;
villiated extensions attached to the backing and comprised of an electroconductive material and providing a surface area for the growth of microorganisms and for transmitting an electric current.

17. A microbial fuel cell according to claim 16, wherein the oxygen barrier is not chemically functionalized.

18. A microbial fuel cell according to claim 16, wherein the oxygen barrier comprises polydimethyl siloxane (PDMS).

19. A microbial fuel cell according to claim 16, wherein the anode chamber is configured for substantially linear flow of liquid through the anode.

20. A microbial fuel cell according to claim 16, wherein the anode chamber is comprised in a generally circular form and the cathode chamber surrounds the anode chamber along at least one axis.

21. A microbial fuel cell according to claim 20, wherein the villiated extensions are comprised of graphite.

22. A microbial fuel cell according to claim 21, wherein the villiated extensions are graphite fibers.

23. A microbial fuel cell according to claim 16, wherein the anode is a packed bed anode and comprises a plurality of spherically shaped objects, and the spherically shaped objects comprise villiated extensions.

24. A microbial fuel cell according to claim 23, wherein the spherically shaped objects are hollow and have an exterior surface and an interior surface, wherein the spherically shaped objects have holes, and further comprise villiated extensions on the interior and/or exterior surfaces.

25. A plurality of microbial fuel cells according to claim 16, comprised in tandem to form a module of microbial fuel cells, wherein a fluid passage connects the anode compartment of one fuel cell with the anode compartment of another fuel cell.

26. A microbial fuel cell comprising:
a chemically-treated anode, wherein the anode comprises an electroconductive material and provides a surface area for supporting a population of microorganisms;
a heat-treated cathode, wherein the cathode comprises an electroconductive material that receives electrons from the anode;
an electrically conductive path connecting the anode to the cathode and allowing for an electrical current to pass between the anode and the cathode.

27. A microbial fuel cell according to claim 26, wherein the anode is chemically-treated with acetone or sodium hydroxide.

28. A microbial fuel cell according to claim 26, wherein the anode further comprises an electrode backing that is an electroconductive mesh.

29. A microbial fuel cell according to claim 28, wherein the anode further comprises villiated extensions attached to the electrode backing further wherein the electrode backing and the villiated extensions are comprised of an electroconductive material.

30. A microbial fuel cell according to claim 29, wherein the villiated extensions are comprised of a material selected from the group consisting of: graphite, graphite-doped ceramic, carbon, a conducting polymer, polyaniline, steel, titanium, copper, gold, platinum, palladium, or a combination of any two or more thereof.

31. A microbial fuel cell according to claim 30, wherein the villiated extensions are graphite fiber.
